(19) United States
(12) Patent Application Publication
(10) Pub. No.: US 2025/0389096 A1
(43) Pub. Date: Dec. 25, 2025

(54) CONCRETE PILE ANCHOR FOUNDATIONS WITH TOWER BASE FLANGE ANCHORING MECHANISM AND METHOD THEREFOR

(71) Applicant: Allan P. HENDERSON, Bakersfield, CA (US)

(72) Inventor: Allan P. HENDERSON, Bakersfield, CA (US)

(21) Appl. No.: 19/238,975

(22) Filed: Jun. 16, 2025

Related U.S. Application Data
(60) Provisional application No. 63/663,854, filed on Jun. 25, 2024.

(51) Int. Cl. E02D 27/12; E02D 27/42

(52) U.S. Cl. CPC E02D 27/12; E02D 27/425

(57) ABSTRACT

A novel concrete pile anchor foundation is disclosed for tube and other towers supporting wind turbines and other dynamic structures subject to high recycling upset forces. Anchoring mechanisms engaged with the foundation pile anchors serve to clamp the base flange of the supported tower against the top surface of the concrete pile anchor foundation. In a first embodiment, individual cantilevered anchoring plates spaced around the tower base flange clamp the flange against the top surface of new and existing concrete foundations. In a second embodiment for new construction, two concentric flat anchoring rings clamp the outer side of the tower base flange and the inner side of the tower base flange, respectively, against the concrete foundation top surface.

### CROSS-REFERENCE TO RELATED APPLICATIONS

This application claims the benefit of priority to U.S. Provisional Application for Patent No. 63/663,854, filed Jun. 25, 2024.

### BACKGROUND OF THE INVENTION

### 1. Field of the Invention

The present invention relates to the field of concrete pile anchor foundations for supporting tall, heavy and/or large towers and the like which can be subject to high upset forces. More particularly, the present invention relates to pile anchor foundations for tubular towers and the like which can be subject to long-term catastrophic foundation fatigue failure, especially wind turbine towers.

### 2. Description of the Related Art

There are three concrete foundation design concepts: plain concrete, reinforced concrete and prestressed/post-tension concrete.

Plain concrete foundations are generally lightly loaded in small foundations where loads are well within the strength of concrete tension capacity (10%+ or − of confined concrete strength).

Reinforced concrete utilizes reinforcing steel; generally rebar with perimeter deformations to enhance bonding with the concrete. Rebar has yield strength from 40 ksi to 75 ksi carbon hardened steel. The steel reinforcing is added for temperature control and to increase the tensile strength of the concrete by transferring the micro cracking of the concrete to the steel reinforcing. Most all of the wind turbine concrete foundations are reinforced concrete using rebar steel reinforcing.

Prestressed concrete requires the reinforcing steel to be prestressed, tensioned, and elongated before casting in the concrete, while post-tensioned concrete utilizes sleeves around the reinforcing steel to allow the tensioned steel to be elongated after the concrete has set.

Concrete pier foundations and concrete pile anchor foundations for wind turbines and other tall towers subject to high upset forces are well known in the art, as exemplified by my earlier U.S. patents, U.S. Pat. No. 5,586,417 (the '417 patent), U.S. Pat. Nos. 5,826,387, 6,672,023, 7,533,505, 7,618,217, 7,707,797 (the '797 patent), U.S. Pat. No. 8,720,139 (the '139 patent), U.S. Pat. No. 9,045,878 (the '878 patent), U.S. Pat. No. 9,340,947 (the '947 patent), and U.S. Pat. No. 11,274,412 (the '412 patent), the disclosures of which are expressly incorporated herein by reference as if fully set forth in their entirety.

The pier foundation disclosed in the '417 patent includes an annular concrete foundation formed as a cylinder having an outer boundary shell defined by an outer corrugated metal pipe (CMP) and an inner boundary formed by an inner CMP of smaller diameter than the outer CMP. Elongated high strength steel bolts run from an anchor or embedment ring near the bottom of the concrete cylinder vertically up through the concrete to extend above the upper end of the foundation and through the base flange of a supported tower to be connected on top of the foundation. The steel bolts are encased in sleeves or hollow tubes over a substantial portion of their vertical extent in the concrete to allow the encased portion of the bolts to be stretched and thus tensioned after the concrete has set. With such tensioning of the bolts, the concrete is kept under constant compression while the bolts are always in tension. Thus, the pier foundation in the '417 patent has been referred to as “tensionless” due to the presumed absence of tensile stress on the concrete.

The tower in the '417 patent is tubular and has a circular tower base flange at the bottom, which is supported in a circular groove formed in the top of the concrete foundation. The tower base flange has a number of bolt holes which match the top ends of a corresponding number of steel anchor bolts so that when the tower is positioned onto the foundation the anchor bolt ends extend upwardly through the bolt holes of the tower base flange. The tower is then secured to the top of the foundation by nutting the upper ends of the steel anchor bolts against the adjacent top of the tower base flange. Thus, the steel bolts are referred to as “tower anchor bolts”.

The foundations disclosed in the '878 and '412 patents improve upon the invention of the '417 patent, by providing lateral reinforcement using nutted and sleeved radial steel bolts. In the '878 patent, the radial bolts are positioned to be generally horizontal and to extend laterally between at least an inner corrugated metal pipe embedded vertically in the foundation cap and an outer vertically positioned corrugated pipe that preferably defines the outer perimeter of the foundation cap. In the '412 patent, the radially-extending horizontal bolts are tensioning bolts that, when post-tensioned after concrete pour and set-up, provide tension steel for minimizing bending of the outer CMP collar and enable the collar to share the overturning (upset) loads otherwise borne by the concrete pier alone.

Finally, the '947 patent discloses an annular concrete pile anchor foundation formed as a cylinder for supporting turbine tube towers. The tube tower is mounted to the top surface of the foundation by engagement of the upper ends of the tower anchor bolts of the anchor bolt cage to the tower base flange, in the same manner as disclosed in the '417 patent. The foundation includes inner and outer CMPs, and inner and outer pile anchors positioned to form a perimeter wall in two spaced circular patterns around the center of the foundation adjacent the outer CMP and outside the anchor bolt cage to secure the foundation to the surrounding and supporting soil.

However, with dynamic structures like wind turbines, there are millions of cycles between tension and compression stresses, such as from wind and rotor rotation. Once the concrete starts cracking and gaps increase, the steel stress forces occasioned by the cycling between tension and compression substantially increase. Under such working conditions, the reinforcing steel can fatigue over time causing the cracked concrete foundation catastrophic failure, which occasionally occurs in reinforced steel foundations when the turbine to foundation load exceeds the plain concrete tension strength and cracking occurs. Catastrophic failure, in turn, results in detrimental concrete cracking between the compressed concrete around the perimeter of the post-tensioned tower anchor bolt cage and the non-compressed reinforced concrete of the remainder of the foundation. Therefore, if the wind turbine tower foundation has cracks (other than shallow surface shrinkage cracks), the cracks in the reinforced concrete foundation are going to propagate long-term fatigue, and conic foundation failure will eventually occur. Therefore, there is a need to prevent or address long-term fatigue of the reinforced steel and conic foundation failure in post-tensioned concrete foundations for tube and other towers supporting wind turbines and other dynamic structures subject to high recycling upset forces.

### SUMMARY OF THE INVENTION

The present invention represents an elegant and straight-forward solution to the problem described in the preceding paragraph and provides improvement for reinforcing the stabilizing contact of the tower base flange to the upper surface of the concrete foundation. More specifically, it has been discovered that stabilizing the base flange of the supported tower against the top surface of concrete pile anchor foundations and other like foundations with an anchoring mechanism can serve to prevent long-term fatigue of the reinforcing steel and conic foundation failure in such post-tensioned concrete foundations.

Advantageously, the present invention is applicable to both new construction and the retrofit of existing concrete pile anchor foundations so as to improve the structural integrity thereof.

In accordance with the present invention, it has been found that two different embodiments are considered effective. In a first preferred embodiment, cantilevered anchoring plates serve as clamps for the tower base flange against the top surface of the concrete foundation. In a second preferred embodiment, concentric flat anchoring rings are used instead of the cantilevered anchoring plates to clamp the tower base flange against the top surface of the concrete foundation.

In each instance, the concrete foundation of the present invention is an annular concrete foundation formed as a cylinder having an outer boundary shell defined by an outer corrugated metal pipe (CMP) and an inner boundary shell formed by an inner CMP of smaller diameter than the outer CMP. The tower anchor bolt cage is located horizontally in the annular foundation generally central between the outer CMP and the inner CMP. Positioned on opposite sides of the tower anchor bolt cage are two series of spaced pile anchors each formed in a circular ring. One ring, the outer circular ring, is positioned generally midway between the bolt cage and the adjacent outer CMP, and the other ring, the inner circular ring, is positioned generally midway between the bolt cage and the inner CMP. Preferably, the series of pile anchors in each pair of circular rings is equally spaced, and the pile anchors in the outer circular ring are staggered with respect to the pile anchors in the inner circular ring.

The concrete foundation of the present invention also preferably includes two levels of radially extending horizontal bolts placed near the top of the concrete foundation. The radial bolts are preferably PVC sleeved and pass through both the outer CMP and the inner CMP where they are plated and nutted off, and then post-tensioned after the concrete of the foundation has cured.

In the cantilevered anchoring plate embodiment, a series of individual cantilevered plates are equally spaced around the top of the annular foundation and extend between the inner pile anchor and the adjacent inner tower anchor bolt over the inner side of the tower base flange and the next sequential cantilevered anchoring plate extends between the outer pile anchor and the adjacent outer tower anchor bolt over the outer side of the tower base flange. Each of the bolt upper ends are nutted down onto the respective cantilevered anchoring plates to thus clamp down on both sides of the tower base flange. While not preferred, the individual cantilevered plates can be spaced around the top of the annular foundation other than in an equally spaced alternate fashion, and can even extend side-by-side with an inner cantilevered plate extending between the inner pile anchor and the inner tower anchor bolt over the inner side of the tower base flange and the adjacent outer cantilevered plate extending between the outer pile anchor and the outer tower anchor bolt over the outer side of the tower base flange.

In the flat anchoring ring embodiment, a pair of spaced flat anchoring rings are positioned on each side of the tower wall bottom end in a new construction. The inner flat anchoring ring extends between the inner pile anchors and the inner tower anchor bolts over the inner side of the tower base flange, and the outer flat anchoring ring extends between the outer pile anchors and the outer tower anchor bolts over the outer side of the tower base flange. Preferably, the inner flat anchoring ring is wide enough so that its inner edge extends over the top of the inner CMP and the outer flat anchoring ring is wide enough so that its outer edge extends over the top of the outer CMP.

As should be understood by those skilled in the art, stabilizing the base flange of a supported tower against the top surface of a concrete pile anchor foundation or other like foundation with an anchoring mechanism, such as a series of cantilevered plates or a pair of concentric flat anchoring rings, serves to share the moment and foundation bending loading as well as accepting cycling displacements by the turbine operation to alleviate long-term fatigue of lateral or radial steels, which otherwise might result in catastrophic foundation failure and turbine upset.

It is also possible in accordance with the present invention to reinforce the stabilizing contact of the tower base flange to the upper surface of existing concrete foundations. More specifically, by using the cantilevered anchoring plate embodiment, a series of individual cantilevered anchoring plates can be equally spaced around the top of an existing annular foundation to extend from each existing pile anchor to the adjacent outer tower anchor bolt over the outside of the tower base flange. Similarly, a single segmented flat anchoring ring can be installed on top of an existing annular foundation, and positioned around the bottom end of the tubular wall to extend between each of the existing pile anchors and the existing adjacent outer tower anchor bolts over the outer side of the tower base flange.

In accordance with the foregoing, it is an object of the present invention to reinforce the stabilizing contact of the tower base flange to the upper surface of concrete foundations in newly constructed concrete foundations and existing concrete foundations.

It is a further object of the present invention to stabilize the base flange of the supported tower against the top surface of newly constructed concrete pile anchor foundations and other like foundations utilizing an anchoring mechanism which serves to prevent long-term fatigue of the reinforcing steel and conic failure of such foundations.

Another object of the present invention is to provide a new annular concrete foundation formed as a cylinder having an outer boundary shell defined by an outer CMP and an inner boundary shell formed by an inner CMP of smaller diameter than the outer CMP, with a tower anchor bolt cage positioned generally central between the outer CMP and the inner CMP and a pair of circular rings or series of equally spaced pile anchors, one positioned generally midway between the bolt cage and the adjacent outer CMP and the other positioned generally midway between the bolt cage and the inner CMP.

Yet a further object of the present invention is to provide a series of individual cantilevered anchoring plates which serve as clamps for the tower base flange against the top surface of the concrete foundation, which individual cantilevered plates are spaced around the top of the annular foundation to best distribute overturning loads, and extend between inner pile anchors and adjacent inner tower anchor bolts over the inner side of the tower base flange and between outer pile anchors and adjacent outer tower anchor bolts over the outer side of the tower base flange.

Still a further object of the present invention, in accordance with the preceding object, is to provide a series of individual cantilevered anchoring plates which are equally spaced around the top of the annular foundation and alternately extend between the inner pile anchors and adjacent inner tower anchor bolts over the inner side of the tower base flange and between the outer pile anchors and adjacent outer tower anchor bolts over the outer side of the tower base flange.

It is another object of the present invention to provide a pair of spaced flat anchoring rings positioned on each side of the tower wall bottom end, with the inner flat anchoring ring extending between the inner pile anchors and the inner tower anchor bolts over the inner side of the tower base flange and the outer flat anchoring ring extending between the outer pile anchors and the outer tower anchor bolts over the outer side of the tower base flange.

It is yet another object of the present invention in accordance with the preceding object in which the inner flat anchoring ring is wide enough so that its inner edge extends over the top of the inner CMP and the outer flat anchoring ring is wide enough so that its outer edge extends over the top of the outer CMP.

Still another object of the present invention is to help stabilize the base flange of existing supported towers against the top of existing concrete pile anchor foundations and other like foundations by providing a series of individual cantilevered anchoring plates spaced around the top of the annular foundation which extend between each of the existing pile anchors and the existing adjacent outer tower anchor bolts over the outer side of the tower base flange.

Still yet another object of the present invention is to help stabilize the base flange of existing supported towers against the top of existing concrete pile anchor foundations by providing a single segmented flat anchoring ring which can be positioned around the top of the annular foundation outside the bottom end of the tubular tower wall and extend between each of the existing pile anchors and the existing adjacent outer tower anchor bolts over the outer side of the tower base flange.

The above together with other objects and advantages of the present invention which will become subsequently apparent reside in the details of construction and operation that is more fully hereinafter described and claimed, reference being had to the accompanying drawings forming a part hereof, wherein like numerals refer to like parts throughout.

### BRIEF DESCRIPTION OF THE DRAWINGS

FIG. 1 shows a schematic view of a concrete pile anchor foundation in accordance with the present invention supporting a wind turbine with a tubular tower.

FIG. 2 is a perspective view, partially in section, of a completed annular concrete foundation with post-tensioned rock anchors entitled “Rock Anchor Foundation” constructed in accordance with the present invention, but before mounting the tubular turbine tower and installing an anchoring mechanism according to the present invention.

FIG. 3 is a top plan view of the foundation steel components of the Rock Anchor Foundation with the inner and outer cantilevered anchor plates alternately staggered around the top of the foundation in a preferred equally spaced relationship.

FIG. 4 is a sectional view of the completed annular concrete foundation shown in FIG. 2 and the steel components shown in FIG. 3 taken along line 4-4 of FIG. 3 with the tower base flange set in the foundation grout trough, and showing the staggered inner and outer cantilevered anchor plates extending between the inner and outer pile anchors and the adjacent tower anchor bolts over each side of the tower base flange.

FIG. 4A is an enlarged sectional view of the top portion of the annular concrete foundation encircled as Detail 4A of FIG. 4.

FIG. 5 is a perspective view, partially in section, of another Rock Anchor Foundation with a pair of spaced flat anchoring rings positioned on each side of the tower wall bottom end as the anchoring mechanism, with the inner flat anchoring ring extending between the inner pile anchors and the inner tower anchor bolts over the inner side of the tower base flange, and the outer flat anchoring ring extending between the outer pile anchors and the outer tower anchor bolts over the outer side of the tower base flange.

FIG. 6 is a top plan view of the inner and outer spaced flat anchoring rings of the Rock Anchor Foundation shown in FIG. 5, showing the bolt holes for the rock anchor bolts and the tower anchor bolts.

FIG. 7 is an enlarged sectional view of the Rock Anchor Foundation of FIGS. 5 and 6, similar to FIG. 4A, showing the positioning of the inner and outer flat anchoring rings over the inner and outer sides of the tower base flange, respectively.

FIG. 8 is a perspective view, partially in section, of a completed annular concrete foundation with post-tensioned helical anchors entitled “Helical Anchor Foundation” constructed in accordance with the present invention, but before mounting the tubular turbine tower and installing an anchoring mechanism according to the present invention.

FIG. 9 is a top plan view of the foundation steel components of the Helical Anchor Foundation of FIG. 8 with the inner and outer cantilevered anchor plates alternately staggered around the top of the foundation in a preferred equally spaced relationship.

FIG. 10 is a sectional view of the completed annular concrete foundation shown in FIG. 8 and the steel components shown in FIG. 9 taken along line 10-10 in FIG. 11 with the tower base flange set in the foundation grout trough, and showing both an inner cantilevered anchor plate extending between an inner pile anchor and an inner tower anchor bolt over the inner side of the tower base flange and a staggered outer cantilevered plate extending between an outer pile anchor and an outer tower anchor bolt over the outer side of the tower base flange.

FIG. 10A is an enlarged sectional view of Detail 10A of FIG. 10.

FIG. 10B is an enlarged sectional view of Detail 10B shown in FIG. 10A.

FIG. 11 is a perspective view, partially in section, of an existing concrete pile anchor foundation entitled “Existing Pile Anchor Foundation” to be reconstructed with cantilevered anchoring plates in accordance with the present invention.

FIG. 12 is a top plan view of the Existing Pile Anchor Foundation installed with cantilevered anchoring plates in accordance with the present invention, with the plates equally spaced around the foundation top surface and extending between each of the single ring of pile anchors to the adjacent outer tower anchor bolt over the outer side of the tower base flange.

FIG. 13 is a partial section view of some of the Existing Pile Anchor Foundation components and the cantilevered anchor plates of the present invention positioned between the pile anchors and outer tower anchor bolts on opposite sides of the cylindrical concrete foundation.

FIG. 13A is an enlarged view of Detail 13A shown in FIG. 13.

FIG. 14 is a top view of a cantilevered anchoring plate to be installed in the Existing Pile Anchor Foundation in accordance with FIGS. 12, 13, and 13A.

### DETAILED DESCRIPTION OF THE PREFERRED EMBODIMENTS

Although preferred embodiments of the present invention are explained in detail, it is to be understood that the invention is not limited in its scope to the details of construction and arrangement of components of these specific embodiments. The invention is capable of other embodiments and being practiced or carried out in various ways. Also, in describing the preferred embodiments illustrated in the drawings, specific terminology will be resorted to for the sake of clarity. However, the invention is not intended to be limited to the specific terms so selected, and it needs to be understood that each specific term includes all technical equivalents which operate in a similar manner to accomplish a similar purpose.

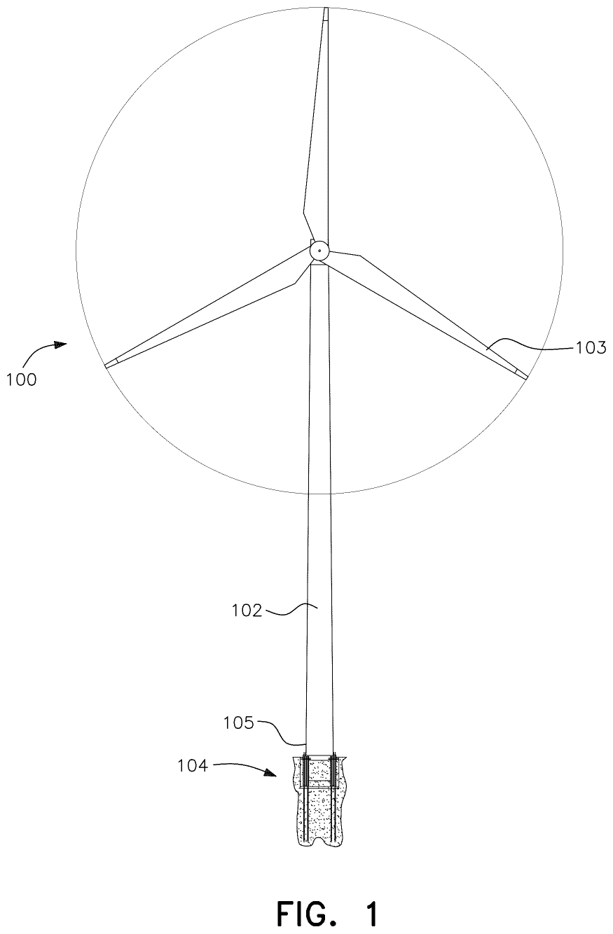

Referring to the drawings, FIG. 1 shows a wind turbine, generally designated by reference numeral 100, with a tubular tower 102 mounted on a schematically illustrated concrete foundation, generally designated by reference number 104, constructed in accordance with the present invention. The tubular tower 102 has a wall bottom end 105 which terminates in a tower base flange for connection to the upper surface of the concrete foundation 104 and a turbine rotor 103 for rotation at its upper end.

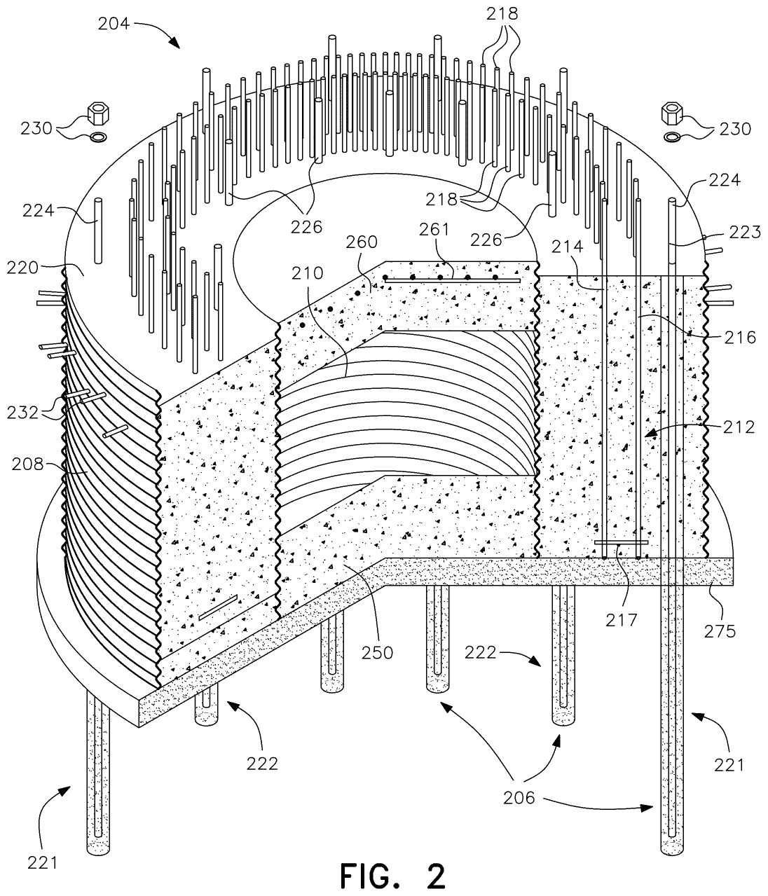

The first preferred embodiment of the present invention is illustrated in detail in FIGS. 2-4A. FIG. 2 shows a completed concrete foundation, generally designated by reference numeral 204, entitled “Rock Anchor Foundation” with a plurality of rock pile anchors, or more simply “rock anchors”, generally designated by reference numeral 206, which are well known in the art. The concrete foundation 204 has an annular shape formed as a cylinder having an outer boundary shell defined by an outer corrugated metal pipe (CMP) 208 and an inner boundary shell formed by inner CMP 210 of smaller diameter. A leveling course 275, approximately twelve (12) inches in thickness, is formed at the bottom of the concrete foundation 204.

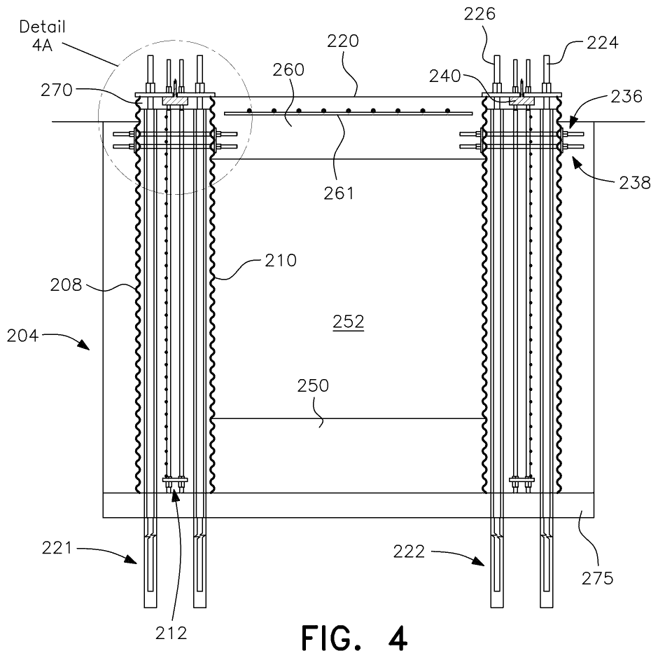

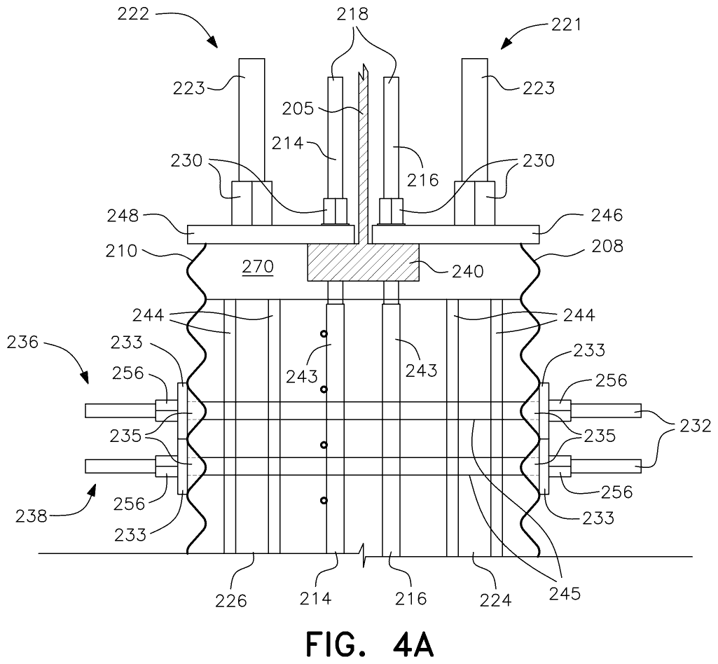

A tower anchor bolt cage, generally designated by reference numeral 212, is located in the annular foundation generally central between the outer CMP 208 and the inner CMP 210. The tower anchor bolt cage 212 is typical of that used in tall tower concrete foundations and includes an inner ring or series of inner tower anchor bolts 214 and an outer ring or series of outer tower anchor bolts 216 which extend vertically upwardly from an embedment ring 217 near the bottom of the concrete foundation to upper ends 218 which extend above the upper surface 220 of the concrete foundation 204. The portion of the tower anchor bolts 214, 216 which extend vertically through the concrete foundation 204 are sleeved with PVC tubing 243 (see FIG. 4A), or otherwise encased, to allow post tensioning after the concrete has solidified, as is known in the art.

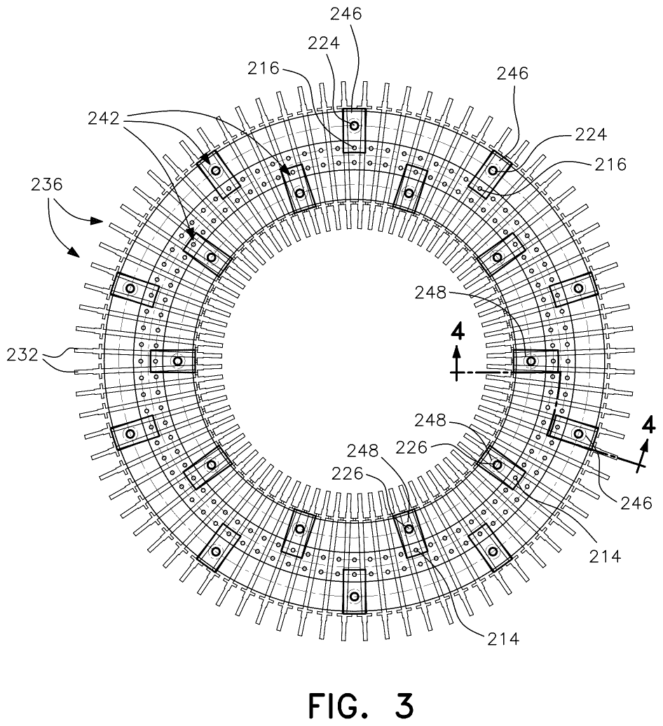

The plurality of rock anchors 206 include a pair of circular rings or series of spaced rock anchors, generally designated by reference numerals 221 and 222, which, according to the present invention, are positioned on opposite sides of the tower bolt cage 212. The outer rock anchors 221 are positioned generally midway between the bolt cage 212 and the adjacent outer CMP 208, and the inner rock anchors 222 are positioned generally midway between the bolt cage 212 and the inner CMP 210. As shown in FIGS. 2 and 3, both series of rock anchors 221, 222 are equally spaced around their respective circular paths, but the rock anchors in each circular ring are preferably staggered with respect to each other so that each outer rock anchor 221 is positioned generally midway between the closest two inner rock anchors 222, and vice versa. The rock anchors 221, 222 include rock anchor bolts 224, 226 which extend their entire length.

The portion of the rock anchor bolts 224, 226 which extend vertically through the concrete foundation 204 are also sleeved with PVC tubing 244, or otherwise encased, to allow post-tensioning after the concrete has solidified, as is known in the art. As also known in the art, the upper ends 223 of the rock anchor bolts 224, 226 extend above the upper surface 220 of the concrete foundation 204 and are to be nutted off by appropriate nuts and washers, identified by reference numeral 230, for post-tensioning and securement.

The concrete foundation 204 in accordance with the present invention preferably includes two levels of radially extending horizontal bolts 232. The two levels, an upper level generally designated by reference numeral 236 and a lower level generally designated by reference numeral 238, are preferably positioned near the top of the concrete foundation 204. See FIGS. 4 and 4A. The radial bolts pass through the outer CMP 208 and the inner CMP 210 to provide hoop and vertical steel reinforcement, as well as bolt support before the foundation 204 pour is made. The horizontally extending radial bolts 232 are nutted at 256 outside the perimeter defining CMP 208 and inside the inner defining CMP 210. The radial bolts 232, which also preferably have PVC sleeves 245, are post-tensioned from the perimeter of the concrete foundation 204, following pour and cure of the concrete foundation. The PVC sleeves 245 preferably extend on the radial bolts 232 outside each of the outer CMP 208 and inner CMP 210, and butt up against the inner surface of the steel plates 233. See FIG. 4A.

In addition, the levels of the radial bolts 232 are positioned so that the outer ends extend through a valley in each of the outer CMP 208 and the inner CMP 210, as shown in FIG. 4A. The exposed ends are preferably fitted with corrugation filler molds 235, as disclosed in my pending provisional application for patent, No. 63/493,129, filed Mar. 30, 2023, which molds are filled with concrete during the pour, as described in the aforesaid application. The disclosure of the aforesaid provisional application for patent is expressly incorporated herein by reference as if fully set forth in its entirety.

The concrete foundation 204 also includes a concrete plug 250 formed in the bottom of the inner CMP 210, after which the area 252 inside the inner CMP atop the plug can be back filled with soil to approximately five (5) feet below the surrounding ground surface. Alternately, the entire area inside the inner CMP 210 may be filled with concrete. Electrical, communication, and grounding conduits (not shown) are installed through the inner and outer CMPs 210, 208. A concrete floor 260, preferably with a rebar mat 261 and having a preferred thickness of about thirty (30) inches, completes the top of the annular space inside the inner CMP 210.

The tubular tower to be supported and stabilized on the concrete foundation 204 includes a tubular wall bottom end 205 which terminates in tower base flange 240. The tower base flange 240 is supported in a circular groove formed in the grout 270 at the top of the concrete foundation 204. The grout 270 is typically about the top six (6) inches above the concrete between the inner and outer CMPs and serves to allow leveling of the tower base flange 240 with shims as is known in the art. The flange 240 has bolt holes which match the upper ends 218 of the inner tower bolts 214 and outer tower bolts 216 on either side of the tower bottom wall 205. See FIGS. 4 and 4A.

As best shown in FIG. 3, a series of individual cantilevered plates, generally designated by reference numeral 242 (for this embodiment the cantilevered plates are referred to as “rock anchor plates” or simply “plates”) are spaced around the upper surface 220 of foundation 204. The individual plates 242 include a series of outer rock anchor plates 246 and a series of inner rock anchor plates 248, which are preferably equally spaced in their respective circular rings, but staggered with respect to each other. As shown in FIG. 3, there are ten (10) outer rock anchor plates 246 and ten (10) inner rock anchor plates 248, but the number of plates can be varied depending upon the particular application and size of the concrete foundation 204. The inner rock anchor plates 248 extend between the inner rock anchors 222 and their adjacent inner tower anchor bolts 214 over the inner side of the tower base flange 240, and the outer rock anchor plates 246 extend between the outer rock anchors 221 and the adjacent outer tower bolts 216 over the outer side of the tower base flange 240. Preferably, the inner rock anchor plates 248 are long enough to extend over the top edge of the inner CMP 210, and the outer rock anchor plates 246 are long enough to extend over the top edge of the outer CMP 208.

Each of the bolt upper ends of the inner tower anchor bolts 214, the outer tower anchor bolts 216, the inner rock anchors 222, and the outer rock anchors 221 can be nutted down against their respective inner rock anchors plates 248 and outer rock anchor plates 246 to thus stabilize and secure the inner side and the outer side of the tower base flange 240.

### One Embodiment Construction for Rock Anchor Foundations

### Rock Anchors

1. Dig foundation excavation using percussion hammer or rock fracture blast and excavator.
2. Pour one 12 inch (+) leveling course of seven (7) sack sand cement slurry with superplasticizer to flow level at bottom of excavation.
3. Install outer CMP 208 and slurry (4 sack) annular space between edge of excavation and outer CMP to four (4) feet below subgrade.
4. Install preassembled tower anchor bolt cage 212 centered and atop leveling course. Shim under bolt cage to plumb bolt cage vertically, if required. Bottom one-half of bolt cage to be wrapped with 0.6 inch strand beginning six (6) inches above embedment ring 217 and space wire tie at six (6) inches on center to anchor cage mid-point. Strand to be wire tied to outer tower anchor sleeves.
5. Install inner CMP 210, shim if required to plumb.
6. Pour 6,000 PSI concrete plug 250 inside inner CMP 210.
7. After 6,000 psi set to minimum 500 PSI or one (1) day, backfill area 252 above plug 250 up to approximately five (5) feet below top of inner CMP 210 to allow electrical works to be installed.
8. Install electrical works (electrical conduits, communication conduits, and turbine grounding) per electrical engineer's plans and specifications.
9. Install radial bolts 232 with PVC sleeves (plate to plate), corrugated filler molds 235, six (6) inch x six (6) inch x one (1) inch steel plates 233, washers and nuts 256. See FIG. 4A.
10. Backfill inner CMP 210 to within thirty (30) inches of top of inner CMP.
11. Install floor rebar mat 261 inside inner CMP 210.
12. Pour 6,000 PSI concrete between CMPs 208, 210 to within six (6) inches of the top of the outer CMP 208 and inner CMP 210 for floor.
13. Post-tension radial bolts 232 after 6,000 PSI concrete reach 4,000 PSI.
14. Wrap perimeter of outer CMP 208 with four (4) feet (+/−) of one (1) inch foam rubber with adhesive on one side to bond to CMP. Cut holes to fit over radial bolts.
15. Extend electrical works beyond backfill.
16. Backfill annular space between edge of excavation and outer CMP 208 with tamped soil. Slope top to one (1) foot of backfill to top of outer CMP 208 to provide positive drainage away from foundation.
17. Percussion drill six (6) inch (+/−) holes to design depth, install all rock anchors 221, 222 with PVC sleeves 244 through foundation concrete and wrapped with grout tube.
18. Grout fill drilled holes to top of foundation excavation.
19. Remove upper tower anchor bolt ring for continued use on other foundations.

### Method of Setting Tower on Rock Anchor Foundation

A. Set tower base flange 240 on shims (at least 3 shim packs) so flange is level with top of CMPs 208, 210 (highest point) being the top of the foundation.
B. Set rock anchor plates 246, 248 about (two (2) inch x nine (9) inch x thirty (30) inch) over the upper ends 223 of 2½ inch rock anchor bolts 224, 226 and 1⅜ gr 150 (ultimate strength of 150,000 PSI steel) adjacent tower anchor bolts 214, 216.
C. Pour 10,000 PSI grout into six (6) inch deep trough between CMPs with 10 sack class II cement with pea gravel and superplasticizer. Verify slurry strength with trial batch samples before beginning foundation construction. Vibrate, if required. Grout to be level with top of tower base flange 240 in contact with rock anchor plates 246, 248.
D. Post-tension tower anchor bolts 214, 216 using dial indicator to verify bolt elongation.
E. Post-tension rock anchor bolts 224, 226 using dial indicator to verify bolt elongation to complete a method of setting tower.

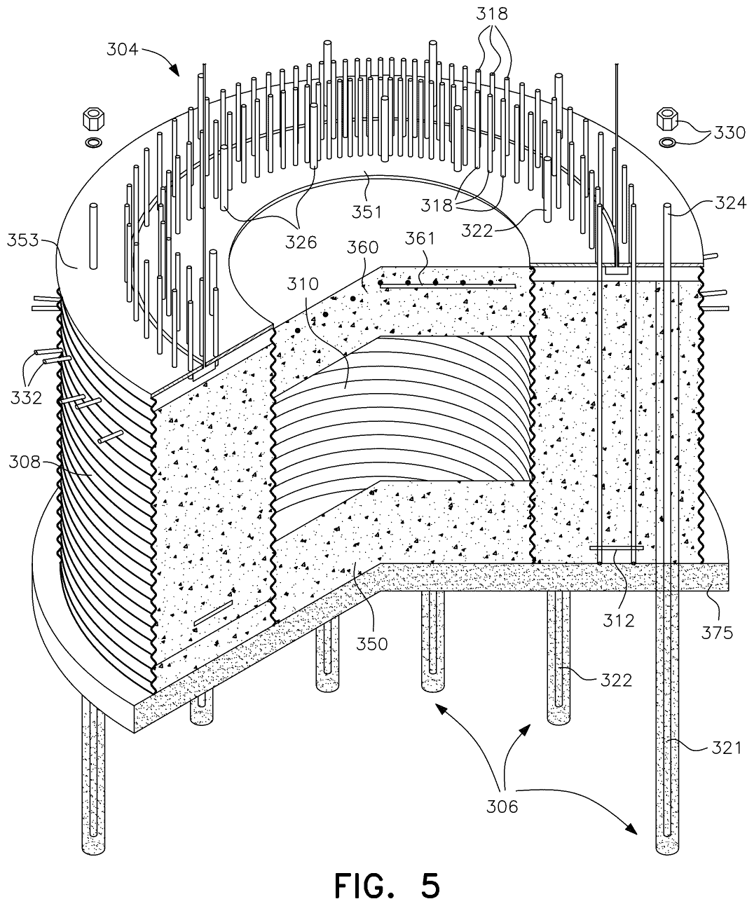

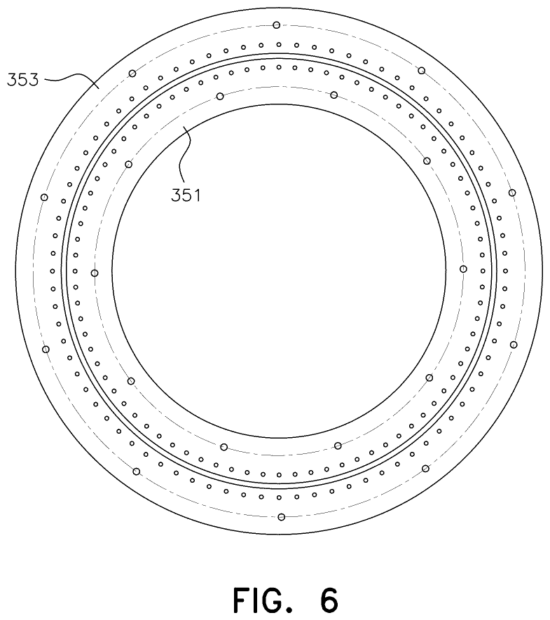

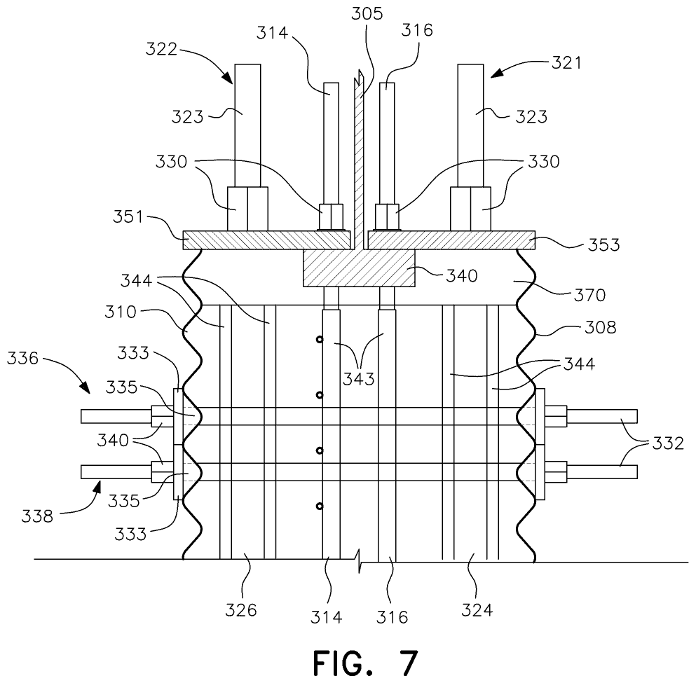

The second preferred embodiment of the present invention is illustrated in detail in FIGS. 5-7. FIG. 5 shows the completed concrete foundation, generally designated by reference numeral 304, which is also a “Rock Anchor Foundation” with a plurality of rock anchors, generally designated by reference numeral 306. Since the foundation 304 of the second preferred embodiment is the same as foundation 204 of the first preferred embodiment, a detailed description of the foundation 304 should not be necessary for those skilled in the art and therefore will not be recited again herein. The components of the concrete foundation 304 which are the same as the components of concrete foundation 204 will have the same numbering on FIGS. 5-7, except that they will be identified in the 300 number series, instead of the 200 number series in drawing FIGS. 2-4A.

However, it is emphasized that the pair of circular rings or series of spaced rock anchors 321 and 322 are positioned on opposite sides of the tower bolt cage 312, in accordance with the present invention when possible for new constructions. This positioning of the rock anchors facilitates the installation of a stabilizing anchoring mechanism over both the inner side of the tower base flange 340 and the outer side of the tower base flange 340.

The difference in the second preferred embodiment is that a pair of spaced flat anchoring rings, an inner ring 351 and an outer ring 353, are positioned along each side of the tower wall bottom end 305 instead of the individual cantilevered plates or rock anchor plates 246, 248. The inner flat anchoring ring 351 has bolt holes to receive therethrough the upper ends 323 of the inner rock anchor bolts 326 and the inner tower anchor bolts 314 over the inner side of the tower base flange 340. The outer rock anchor ring 353 has bolt holes therein to receive therethrough the upper ends 323 of the outer rock anchor bolts 324 and the outer tower anchor bolts 316 over the outer side of the tower base flange 340. Preferably, the inner rock anchor ring 351 is wide enough to extend over the top edge of the inner CMP 310 and the outer rock anchor ring 353 is wide enough to extend over the top edge of the outer CMP 308.

As with the first preferred embodiment, the upper ends of each of the inner tower anchor bolts 314, the outer tower anchor bolts 316, the inner rock anchor bolts 326, and the outer rock anchor bolts 324 can be nutted down against their respective inner and outer rock anchor rings 351, 353 to thus stabilize and secure the inner side and the outer side of the tower base flange 340.

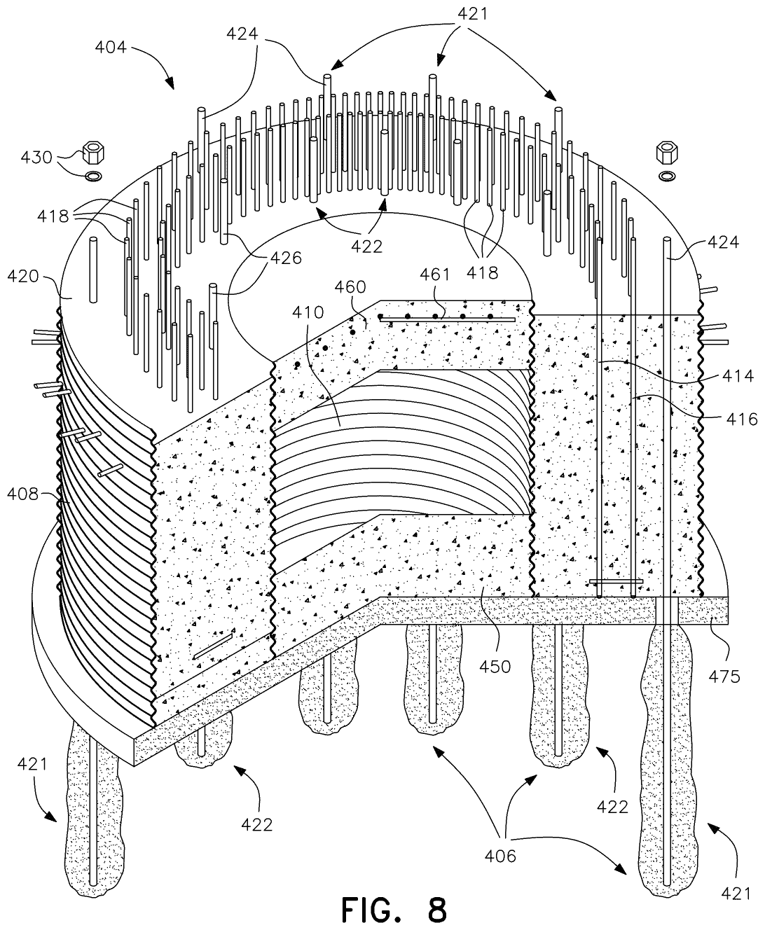

A third preferred embodiment of the present invention is illustrated in detail in FIGS. 8-10B. FIG. 8 shows a completed concrete foundation, generally designated by reference numeral 404, entitled “Helical Anchor Foundation” with a plurality of helical pile anchors, or more simply “helical anchors”, generally designated by reference numeral 406, which are well known in the art. The concrete foundation 404 has an annular shape formed as a cylinder having an outer boundary shell defined by an outer corrugated metal pipe (CMP) 408 and an inner boundary shell formed by inner CMP 410 of smaller diameter. A leveling course 450 is formed at the bottom of the concrete foundation 404.

Although the concrete foundation 404 of the third preferred embodiment is the same as the concrete foundation 204 of the first preferred embodiment, except for the substitution of helical anchors 406 instead of rock anchors 206, a detailed description of the foundation 404 will be provided for further understanding of the present invention. The components of the concrete foundation 404 which correspond to the components of concrete foundation 204 will have the same numbering on FIGS. 8-10B, except that they will be identified in the 400 numbered series, instead of the 200 numbered series on drawings FIGS. 2-4A.

More specifically, the tower anchor bolt cage, generally designated by reference numeral 412, is located in the annular foundation generally central between the outer CMP 208 and the inner CMP 410. As known in the art, the tower anchor bolt cage 412 includes an inner ring or series of inner tower bolts 414 and an outer ring or series of outer tower bolts 416 which extend vertically upwardly from an embedment ring 417 near the bottom of the concrete foundation to upper ends 418 which extend above the upper surface 420 of the concrete foundation 404. The portion of the anchor bolts 414, 416 which extend vertically through the concrete foundation 404 are sleeved with PVC tubing 443, or otherwise encased, to allow post tensioning of the tower bolts 414, 416 after the concrete has solidified, as is also known in the art.

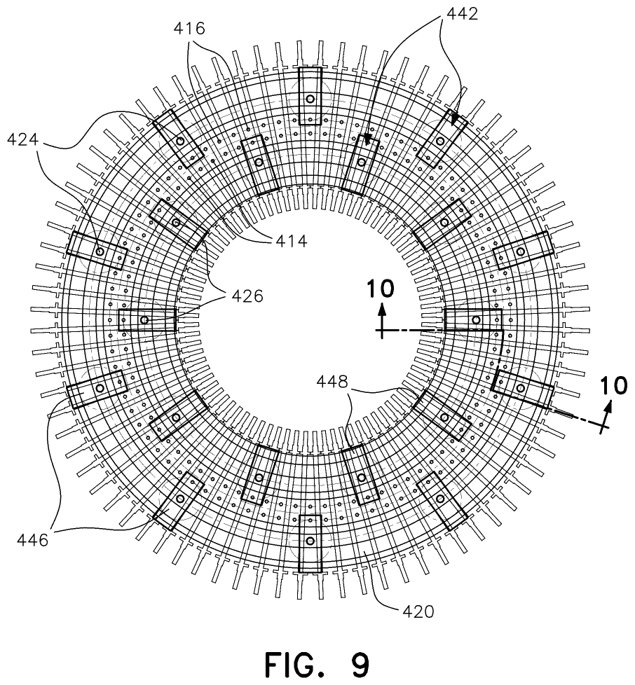

The plurality of helical anchors 406 include a pair of circular rings or series of spaced helical anchors, generally designated by reference numerals 421 and 422, which, according to the present invention, are positioned on opposite sides of the tower bolt cage 412. The outer helical anchors 421 are positioned generally midway between the bolt cage 412 and the adjacent outer CMP 408, and the inner helical anchors 422 are positioned generally midway between the bolt cage 412 and the inner CMP 410. As shown in FIGS. 8 and 9 both series of helical anchors 421, 422 are equally spaced around their respective circular paths, but the helical anchors in each circular ring are preferably staggered with respect to each other so that each outer helical anchor 421 is positioned generally midway between the closest two inner helical anchors 422, and vice versa. The outer and inner helical anchors 421, 422 include outer and inner helical anchor bolts 424, 426 which extend their entire length.

The portion of the helical anchors 421, 422 which extend vertically through the concrete foundation 404 are also sleeved with PVC tubing 444, or otherwise encased, to allow post-tensioning after the concrete has solidified, as is known in the art. As also known in the art, the upper ends 423 of the helical anchor bolts 424, 426 extend above the upper surface 420 of the concrete foundation 404 and are to be nutted off by appropriate nuts and washers, identified by reference numeral 430, for post-tensioning and securement.

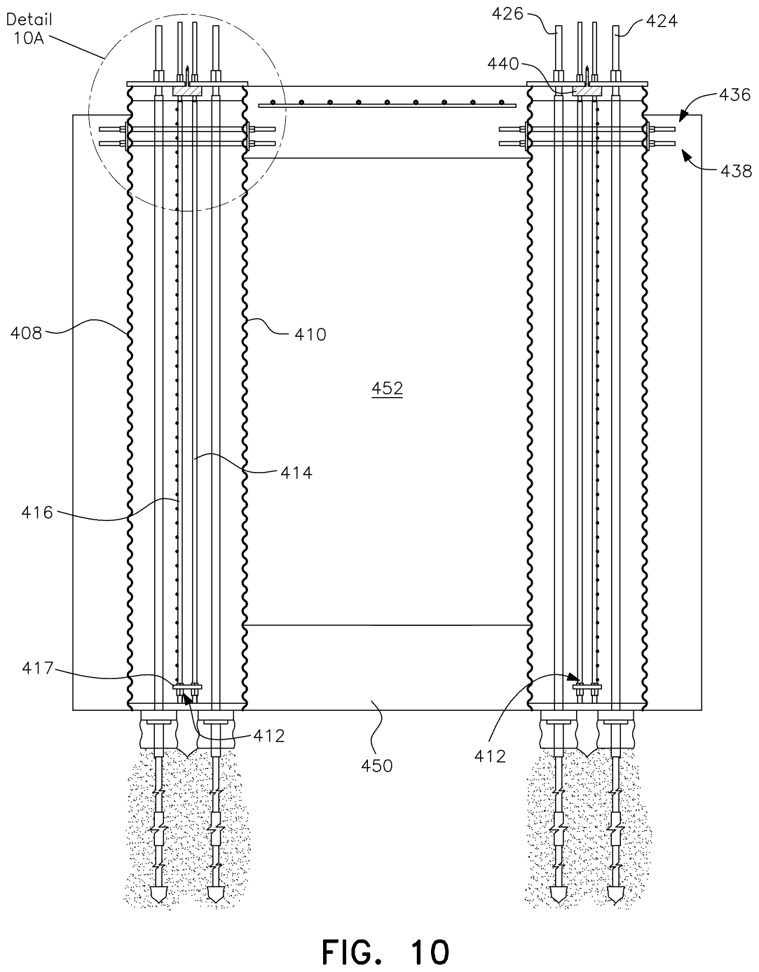

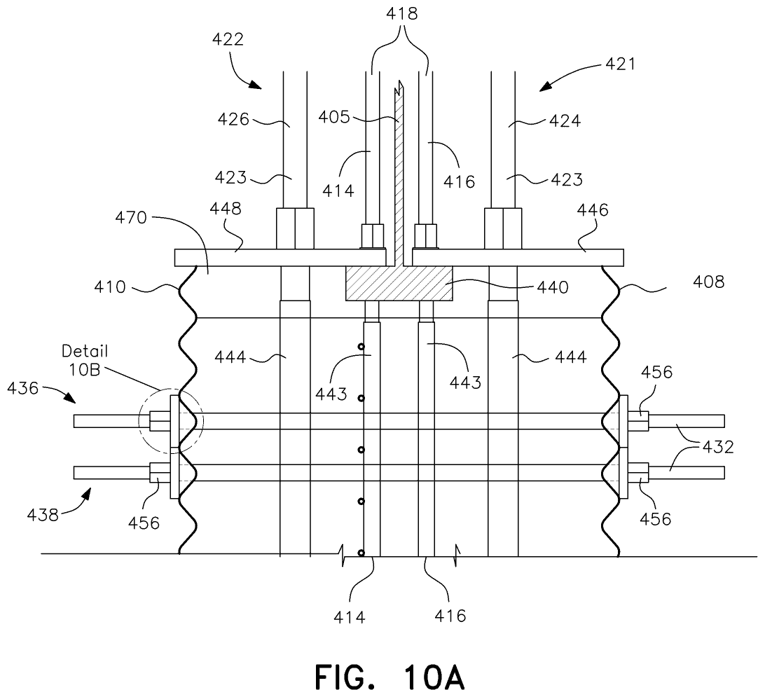

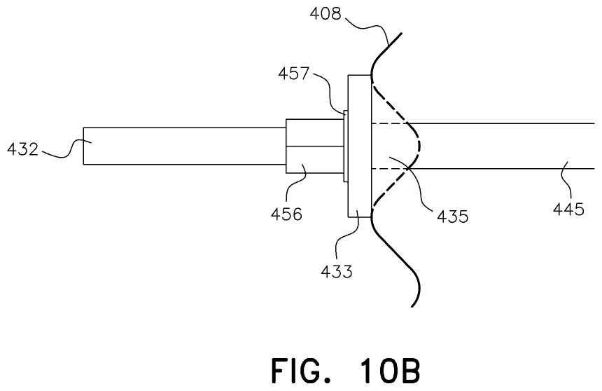

The concrete foundation 404 in accordance with the present invention preferably includes two levels of radially extending horizontal bolts 432. The two levels, an upper level generally designated by reference numeral 436 and a lower level generally designated by reference numeral 438, are preferably positioned near the top of the concrete foundation 404. See FIGS. 10 and 10A. The radial bolts pass through the outer CMP 408 and the inner CMP 410 to provide hoop and vertical steel reinforcement, as well as bolt support before the foundation 404 pour is made. The horizontally extending radial bolts 432 are nutted at 456 preferably with washers 457 outside the perimeter defining CMP 408 and inside the inner defining CMP 410. The radial bolts 432, which also preferably have PVC sleeves 445, are post-tensioned from the perimeter of the concrete foundation 404, following pour and cure of the concrete foundation. The PVC sleeves 445 preferably extend on the radial bolts 432 outside each of the outer CMP 408 and inner CMP 410, and butt up against the inner surface of the steel plates 433. See FIG. 10A.

In addition, the levels of the radial bolts 432 are positioned so that the outer ends extend through a valley in each of the outer CMP 408 and the inner CMP 410, as shown in FIGS. 10A and 10B. The exposed ends are preferably fitted with corrugation filler molds 435, as disclosed in my aforesaid pending provisional application for patent, No. 63/493,129, and illustrated in FIGS. 10A and 10B. As described in the application, molds 435 are filled with cementitious material during the pour, or otherwise, to fill the mold cavity and provide a solid cap or collar between the wall of the CMP 408 and the opposite wall of the adjacent plate 433 once the cementitious material has cured. The solid cap or collar thus stabilizes the projecting end of the radial bolts 432 during post-tensioning.

The concrete foundation 404 also includes a concrete plug 450 formed in the bottom of the inner CMP 410, after which the area 452 inside the inner CMP atop the plug can be back filled with soil to approximately five (5) feet below the surrounding ground surface. Alternately, the entire area inside the inner CMP 410 may be filled with concrete. Electrical, communication, and grounding conduits (not shown) are installed through the inner and outer CMPs 410, 408. A concrete floor 460, preferably with a rebar mat 461 and having a preferred thickness of about thirty (30) inches, completes the top of the annular space inside the inner CMP 410.

The tubular tower to be supported and stabilized on the concrete foundation 404 includes a tubular wall bottom end 405 which terminates in tower base flange 440. The tower base flange 440 is supported in a circular groove formed in the grout 470 at the top of the concrete foundation 404. The flange 440 has bolt holes which match the upper ends 418 of the inner tower bolts 414 and outer tower bolts 416 on either side of the tower bottom wall 405. See FIGS. 10 and 10A.

As best shown in FIG. 9, a series of individual cantilevered plates, generally designated by reference numeral 442 (for this embodiment the cantilevered plates are referred to as “helical anchor plates”) are spaced around the upper surface 420 of foundation 404. The individual plates 442 include a series of outer helical anchor plates 446 and a series of inner helical anchor plates 448, which are preferably equally spaced in their respective circular rings, but staggered with respect to each other. As shown, there are ten (10) outer helical anchor plates 446 and ten (10) inner helical anchor plates 448, but the number of helical anchor plates can be varied depending upon the particular application and size of the concrete foundation 404. Preferably, there is a helical anchor plate 442 for each outer helical anchor 421 and each inner helical anchor 422.

The inner helical anchor plates 448 extend between the inner helical anchors 422 and their adjacent inner tower anchor bolts 414 over the inner side of the tower base flange 440, and the outer helical anchor plates 446 extend between the outer helical anchors 421 and the adjacent outer tower bolts 416 over the outer side of the tower base flange 440. Preferably, the inner helical anchor plates 448 are long enough to extend over the top edge of the inner CMP 410, and the outer helical anchor plates 446 are long enough to extend over the top edge of the outer CMP 408.

Each of the bolt upper ends of the inner tower anchor bolts 414, the outer tower anchor bolts 416, the inner helical anchors 422, and the outer helical anchors 421 can be nutted down against their respective inner helical anchors plates 448 and outer helical anchor plates 446 to thus stabilize and secure the inner side and the outer side of the tower base flange 440.

Since an exemplary construction schedule for the Helical Anchor Foundation as described above would be the same or similar to that previously described for the Rock Anchor Foundation, an exemplary construction schedule for the Helical Anchor Foundation should not be necessary for those skilled in the art.

The method for stabilizing wind turbine towers and other tall, heavy and/or large towers and the like on newly constructed concrete pile anchor foundations in accordance with the present invention should be readily apparent to those skilled in the art based upon the foregoing descriptions. The method contemplates the installation of an anchoring mechanism, whether separate cantilevered plates or an anchoring flat ring, to extend between the inner pile anchor bolts and adjacent inner tower anchor bolts over the inner side of the tower base flange and a similar anchoring mechanism to extend between the outer pile anchor bolts and the adjacent outer tower anchor bolts over the outer side of the tower base flange. The anchoring mechanisms thus serve to better clamp the tower base flange on the upper surface of the concrete pile anchor foundation.

Further, it is possible to reinforce the stabilizing contact of a tower base flange to the upper surface of an existing concrete pile anchor foundation in accordance with the present invention, where the installed wind turbine tower is already previously been installed on the existing concrete foundation, and it is no longer feasible to separate the installed tower from the foundation, or otherwise access to the inner tower anchor bolts.

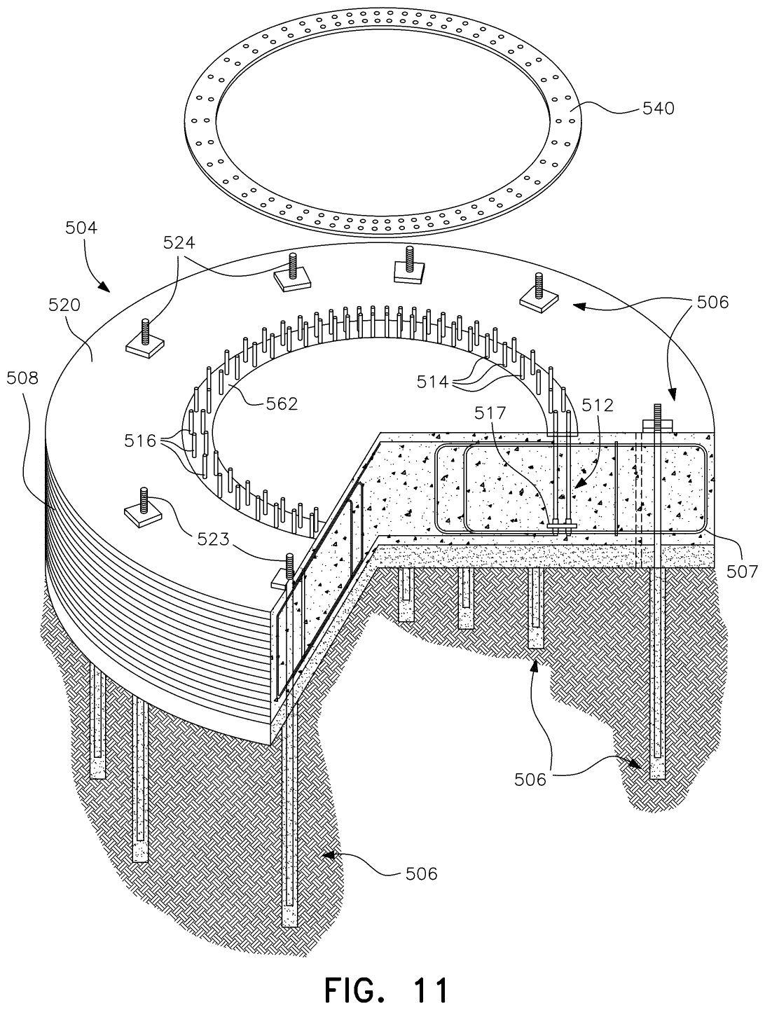

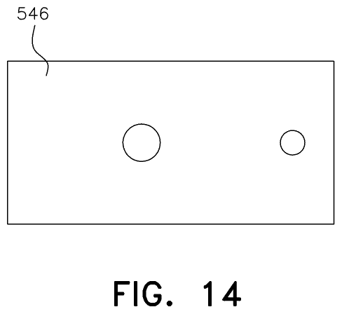

Such an embodiment of the present invention whereby the stabilizing contact of the tower base flange to the upper surface can be improved in a concrete foundation of an existing wind turbine installation is illustrated in detail in FIGS. 11-14. Again, where the components of this embodiment correspond with the components of the previously described new construction concrete foundation embodiments, the same number system will be utilized, except that they will be identified in the 500 numbered series.

FIG. 11 shows an existing concrete foundation (herein referred to as the “Existing Pile Anchor Foundation”), generally designated by reference numeral 504, with a plurality of existing pile anchors, generally designated by reference numeral 506, and showing the tower base flange 540 spaced above an existing inner ring of inner tower anchor bolts 514 and an existing outer ring of outer tower anchor bolts 516. The inner tower anchor bolts 514 and outer tower anchor bolts 516 extend vertically upwardly from an embedment ring 517 of a tower anchor bolt cage, generally designated by reference numeral 512. It will be noted that the Existing Pile Anchor Foundation 504 is a complete cylinder, without an annular shape and no inner CMP.

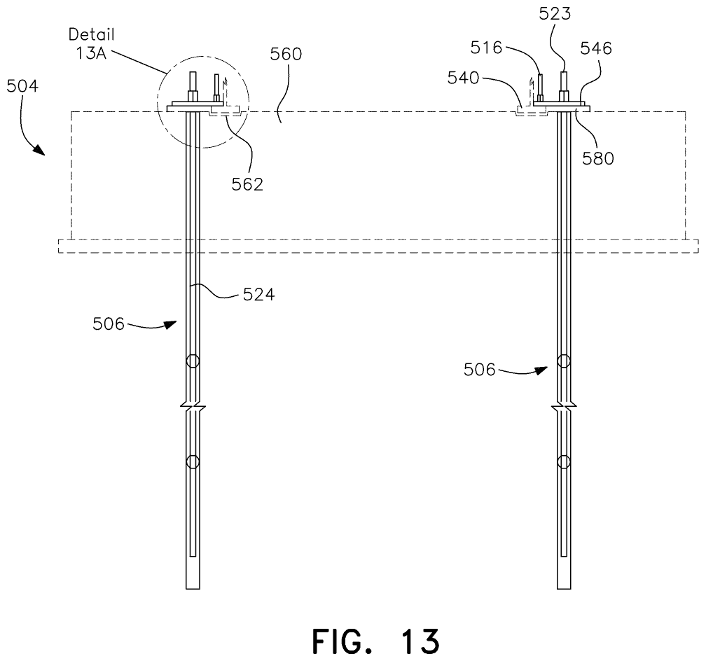

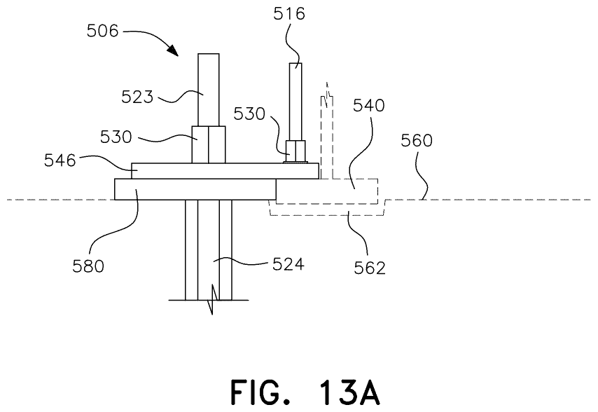

The pile anchors 506 of the Existing Pile Anchor Foundation are arranged in a singular ring positioned generally central between the tower anchor bolt cage 512 and the outer CMP 508 which defines the outer boundary of the concrete foundation 504. The pile anchors 506 include pile anchor bolts 524, which have already been post-tensioned in connection with the original installation of the wind turbine tower base flange 540. As shown in FIGS. 13 and 13A, the tower base flange 540 of the Existing Pile Anchor Foundation is supported in a circular groove 562 formed in the concrete 560 at the top of the concrete foundation 504.

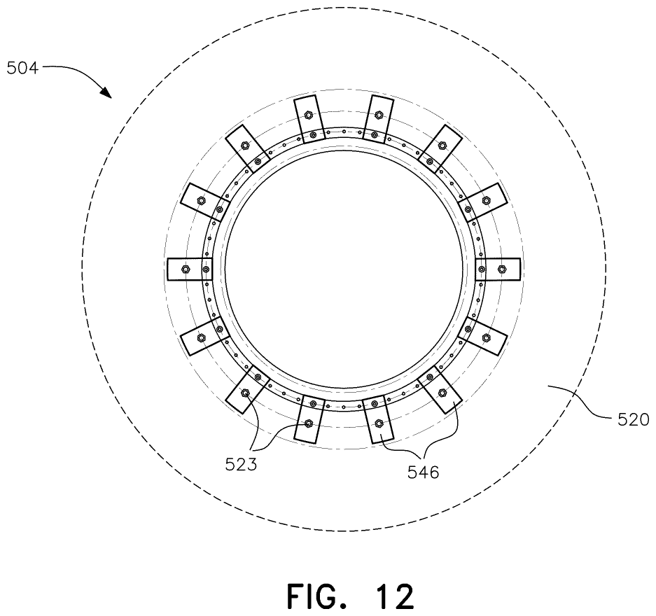

The Existing Pile Anchor Foundation 504 does not include post-tensioned radially extending horizontal bolts corresponding to horizontal bolts 232, 332, and 432 for new construction in accordance with the present invention. Instead, the Existing Pile Anchor Foundation 504 includes radially extending rectangular rebar hoops 507 adjacent each pile anchor 506 and adjacent tower anchor bolts 514 and 516, which hoops are well known in the art. As shown in FIG. 12, a series of individual cantilevered plates 546 (for this embodiment the cantilevered plates are referred to as “pile anchor plates”) are spaced around and grouted atop the upper surface 520 of the foundation 504, and associated with the upper end 523 of each of the existing pile anchors 506. As shown in FIG. 12, there are fourteen (14) pile anchor plates 546. The pile anchor plates 546 extend between the pile anchor bolts 524 and their adjacent outer tower bolts 516 over the outer side of the tower base flange 540.

Of course, prior to the installation of the pile anchor plates 546, the retaining nuts 530 of the pile anchor bolts 524 and tower anchor bolts 516, and any related washers, must first be removed. In order for the pile anchor plate 546 to be level in view of the thickness of the tower base flange 540, a layer of high strength grout 580 is installed on top of the concrete 560 adjacent the outer edge of the tower base flange 540 and around the upper ends 523 of the pile anchor bolts 524. Once the layer of high strength grout 580 has cured and each pile anchor plate 546 is in place over the ends of the pile anchor bolts 524 and tower anchor bolts 516, the existing nuts 530, and related washers, or new nuts can then be installed, nutted down, and thus stabilizing the outer side of the tower base flange 540.

Instead of the separate individual cantilevered plates 546, the present invention also contemplates the use of a single segmented anchoring ring to be positioned around the bottom end of an existing tubular tower wall of a wind turbine, or other tall tower, previously installed and operating on the top of an existing concrete pile anchor foundation. The segmented flat anchoring ring would be sized to extend between each of the existing pile anchor bolts 524 and adjacent outer tower anchor bolts 516.

The cantilevered plates in accordance with the present invention are preferably made from a rust resistant steel, but can be made from any satisfactory galvanized metal or other material whether for new construction or stabilizing existing installations. A suitable size for the cantilevered plates 546 for the Existing Pile Anchor Foundation as described herein, and made of a suitable steel, is approximately 2 inches×12 inches×24 inches. Other sizes, of course, can be utilized depending upon the size of the existing concrete pile anchor foundation and the wind turbine tubular tower or other supported structure, and other factors which may effect stabilizing the tower base flange.

The method for reinforcing the stabilizing contact of a tower base flange to the upper surface of an existing concrete pile anchor foundation in accordance with the present invention should also be readily understood by those skilled in the art from the preceding description. The method contemplates the installation of an anchoring mechanism, whether separate cantilevered anchoring plates or a segmented anchoring ring, extending between the existing pile anchor bolts and the existing adjacent outer tower anchor bolts over the outer side of the tower base flange.

It should be understood by those skilled in the art that the installation of an anchoring mechanism, whether separate cantilevered plates or concentric flat anchoring rings, over the base flange of a supported tower against the top surface of a concrete pile anchor foundation or other like foundation, as described in the preceding embodiments, will serve to prevent long term fatigue of the reinforcing steel and conic foundation failure in such post-tensioned concrete foundations.

As used herein, for the purposes of this specification, including the appended claims, the terms “about” and “approximately” when modifying numbers expressing a number of sizes, dimensions, portions, shapes, formulations, parameters, percentages, quantities, characteristics, and other numerical values used in the specification and claims, the term is meant to encompass the stated value plus or minus 10%

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A concrete pile anchor foundation for supporting tall, heavy and/or large towers, which comprises:
an annular concrete foundation formed as a cylinder and having an outer boundary shell defined by an outer corrugated metal pipe and an inner boundary shell defined by an inner corrugate metal pipe of smaller diameter;
a tower anchor bolt cage located in the concrete foundation generally central between the outer corrugated metal pipe and the inner corrugated metal pipe, the tower anchor bolt cage including an inner ring of inner tower anchor bolts and an outer ring of outer tower anchor bolts which extend vertically upwardly in the concrete foundation from an embedment ring near a bottom of the concrete foundation to upper ends which extend above an upper surface of the concrete foundation, said tower anchor bolts having a sleeve for post-tensioning the bolts after the concrete foundation has been poured and solidified; and
a first and second series of spaced pile anchors each formed in a ring on opposite sides of the tower anchor bolt cage and inside their respective corrugated metal pipes, said pile anchors extending vertically through the concrete foundation with their upper ends extending above the upper surface of the concrete foundation and extending below the concrete foundation to engage the concrete foundation with soil or rock materials below the foundation, said pile anchors having a sleeve for post-tensioning the pile anchors after said concrete foundation has been poured and solidified.

2. The concrete pile anchor foundation of claim 1, wherein the first and second pile anchor rings are circular and the first pile anchor ring is positioned generally midway between the outer corrugated metal pipe and the ring of outer tower anchor bolts and the second circular ring of spaced pile anchors is positioned generally midway between the inner corrugated metal pipe and the ring of inner tower anchor bolts.

3. The concrete pile anchor foundation of claim 2, wherein the spaced pile anchors of the first and second circular rings are equally spaced and the pile anchors of the first circular ring are staggered with respect to the pile anchors of the second circular ring.

4. A combination comprising:
the concrete pile anchor foundation of claim 1;
a tubular wind turbine tower mounted on said upper surface of said foundation, said tower including a tower base flange with bolt holes which receive the upper ends of the inner and outer tower anchor bolts; and
inner and outer anchoring mechanisms around the upper surface of said concrete foundation, the inner anchoring mechanism extending between the inner pile anchors and their adjacent inner tower anchor bolts over the inner side of the tower base flange and the outer anchor mechanism extending between the outer pile anchors and their adjacent outer tower bolts over the outer side of the tower base flange in order to reinforce contact of the tower base flange against the upper surface of said concrete foundation.

5. The combination of claim 4, wherein the inner and outer anchoring mechanisms are individual cantilevered anchoring plates.

6. The combination of claim 5, wherein the individual cantilevered anchoring plates are equally spaced in an inner circular ring and an outer circular ring.

7. The combination of claim 6, wherein the cantilevered anchoring plates of the inner circular ring are staggered with respect to the cantilevered anchoring plates of the outer circular ring.

8. The combination of claim 2, wherein the inner and outer anchoring mechanisms are separate inner and outer flat rings.

9. A method for reinforcing the contact of a tower base flange of a supported tall or heavy tower on an upper surface of a newly constructed concrete pile anchor foundation, said concrete pile anchor foundation having an annular concrete foundation formed as a cylinder and having an outer boundary shell defined by an outer corrugated metal pipe and an inner boundary shell defined by an inner corrugate metal pipe of smaller diameter;
a tower anchor bolt cage located in the concrete foundation generally central between the outer corrugated metal pipe and the inner corrugated metal pipe, the tower anchor bolt cage including an inner ring of inner tower anchor bolts and an outer ring of outer tower anchor bolts which extend vertically upwardly in the concrete foundation from an embedment ring near a bottom of the concrete foundation to upper ends which extend above an upper surface of the concrete foundation, said tower anchor bolts having a sleeve for post-tensioning the bolts after the concrete foundation has been poured and solidified; and
a first and second series of spaced pile anchors each formed in a ring on opposite sides of the tower anchor bolt cage and inside their respective corrugated metal pipes, said pile anchors extending vertically through the concrete foundation with their upper ends extending above the upper surface of the concrete foundation and extending below the concrete foundation to engage the concrete foundation with soil or rock materials below the foundation, said pile anchors having a sleeve for post-tensioning the pile anchors after said concrete foundation has been poured and solidified,
said method comprising:
installing inner and outer anchoring mechanisms around the upper surface of said concrete foundation, the inner anchoring mechanism extending between the inner pile anchors and their adjacent inner tower anchor bolts over the inner side of the tower base flange and the outer anchor mechanism extending between the outer pile anchors and their adjacent outer tower bolts over the outer side of the tower base flange in order to reinforce contact of the tower base flange against the upper surface of said concrete foundation.

10. The method of claim 9, wherein the inner and outer anchoring mechanisms are individual cantilevered anchoring plates.

11. The method of claim 9, wherein the inner and outer anchoring mechanisms are separate inner and outer flat rings.

12. A wind turbine, which comprises:
an annular concrete pile anchor foundation formed as a cylinder having an outer boundary shell defined by an outer corrugated metal pipe and an inner boundary shell defined by an inner corrugate metal pipe of smaller diameter;
a tower anchor bolt cage located in the concrete foundation generally central between the outer corrugated metal pipe and the inner corrugated metal pipe, the tower anchor bolt cage including an inner ring of inner tower anchor bolts and an outer ring of outer tower anchor bolts which extend vertically upwardly in the concrete foundation from an embedment ring near a bottom of the concrete foundation to upper ends which extend above an upper surface of the concrete foundation, said tower anchor bolts having a sleeve for post-tensioning the bolts after the concrete foundation has been poured and solidified;
a first and second series of spaced pile anchors each formed in a ring on opposite sides of the tower anchor bolt cage and inside their respective corrugated metal pipes, said pile anchors extending vertically through the concrete foundation with their upper ends extending above the upper surface of the concrete foundation and extending below the concrete foundation to engage the concrete foundation with soil or rock materials below the foundation, said pile anchors having a sleeve for post-tensioning the pile anchors after said concrete foundation has been poured and solidified;
a tubular tower with a generally horizontal circular tower base flange at a bottom end supported on the upper surface of the concrete foundation; and a rotating turbine at an upper end and
inner and outer anchoring mechanisms around the upper surface of said concrete foundation, the inner anchoring mechanism extending between the inner pile anchors and their adjacent inner tower anchor bolts over the inner side of the tower base flange and the outer anchor mechanism extending between the outer pile anchors and their adjacent outer tower bolts over the outer side of the tower base flange in order to reinforce contact of the tower base flange against the upper surface of said concrete foundation.

13. The wind turbine of claim 12, wherein the inner and outer anchoring mechanisms are individual cantilevered anchoring plates.

14. The wind turbine of claim 13, wherein the individual cantilevered anchoring plates of the inner anchoring mechanism are equally spaced in an inner circular ring and the individual cantilevered anchoring plates of the outer anchoring mechanism are equally spaced in an outer circular ring.

15. The wind turbine of claim 14, wherein the cantilevered anchoring plates of the inner circular ring are staggered with respect to the cantilevered anchoring plates of the outer circular ring.

16. The wind turbine of claim 12, wherein the inner and outer anchoring mechanisms are separate inner and outer flat rings.

17. A method for helping to stabilize a tower base flange of an existing supported tower against a top surface of an existing concrete pile anchor foundation which includes outer pile anchors and adjacent outer tower anchor bolts which comprises:
installing an anchoring mechanism around and over an outer side of the tower base flange, which anchoring mechanism extends between the outer pile anchors and their adjacent outer tower anchor bolts over said outer side of the tower base flange in order to increase the contact of the tower base flange against the top surface of the concrete foundation.

18. The method of claim 17, wherein the anchoring mechanism is a series of individual cantilevered anchoring plates.

19. The method of claim 18, wherein the individual cantilevered anchoring plates are substantially rectangular and are made of rust resistant steel or galvanized metal.

20. The method of claim 17, wherein the outer anchoring mechanism is a single segmented flat anchoring ring.

21. The method of claim 17, wherein the existing supported tower has a rotating turbine at its upper end.

22. The method of claim 9, wherein the installing of the anchoring mechanisms serves to share the moment and foundation bending loading as well as accepting cycling displacements by a turbine operation to alleviate long-term fatigue of lateral or radial steels, otherwise resulting in catastrophic foundation failure and turbine upset.
